(19) United States
(12) Patent Application Publication
(10) Pub. No.: US 2012/0287110 A1
(43) Pub. Date: Nov. 15, 2012

(54) LIQUID CRYSTAL DISPLAY DEVICE, DRIVE METHOD OF LIQUID CRYSTAL DISPLAY DEVICE, AND ELECTRONIC DEVICE

(75) Inventors: Takahiro Yamaguchi, Osaka (JP); Isao Takahashi, Osaka (JP); Seijirou Gyouten, Osaka (JP); Noboru Matsuda, Osaka (JP)

(73) Assignee: SHARP KABUSHIKI KAISHA, Osaka-shi, Osaka (JP)

(21) Appl. No.: 13/515,103

(22) PCT Filed: Oct. 22, 2010
(86) PCT No.: PCT/JP2010/068756

§ 371 Date: Jun. 11, 2012

(30) Foreign Application Priority Data
Dec. 24, 2009 (JP) 2009-293297

(51) Int. Cl. G09G 3/36; G06F 3/038

(52) U.S. Cl. 345/212; 345/87

(57) ABSTRACT

In a liquid crystal display device, an in-phase signal or a reversed phase signal of a signal supplied to a counter electrode is supplied to a source bus line during a video signal unwritten period, where (i) a video signal written period represents a period during which a voltage is applied to a pixel electrode in accordance with a video signal to be supplied to the source bus line and (ii) the video signal unwritten period represents a period between end of the data written period and start of a next data written period. This allows an electronic potential difference between the source bus line and the counter electrode to be kept constant. It is therefore possible to attain a liquid crystal display device excellent in its display quality by preventing flickers from being generated between a source bus line and a counter electrode.

### TECHNICAL FIELD

The present invention relates to a liquid crystal display device having a memory function.

### BACKGROUND ART

Mobile terminals, such as mobile phones, have recently caused a problem of increase in power consumption due to multifunctionality. In order to decrease power consumption of the mobile terminals as much as possible, an effort has been made to reduce power consumption of a liquid crystal display device including a display section that consumes particularly much power.

In order to decrease power consumption of a liquid crystal display device such as a mobile phone, for example, an interval between a video signal and the subsequent video signal to be written in a liquid crystal capacitor provided in a pixel forming section so that a pixel of the pixel forming section is displayed is elongated during display of a screen in which an image less changes, such as time display.

However, such an elongated interval forces the liquid crystal capacitor to hold an applied voltage for a long period of time. In order that the liquid crystal capacitor can hold the applied voltage, the pixel forming section of the liquid crystal display device includes a circuit having a memory function (hereinafter referred to as a pixel memory circuit).

An example of the liquid crystal display device including such a pixel memory circuit is a display device disclosed in Patent Literature 1.

### CITATION LIST

Patent Literature
Patent Literature 1
Japanese Patent Application Publication Tokukai No. 2007-286237 (Publication Date: Nov. 1, 2007)

### SUMMARY OF INVENTION

### Technical Problem

In a general liquid crystal display device, each source bus line is provided between corresponding adjacent pixel electrodes, and a black matrix is provided on the source bus line. This allows the black matrix to hide a flicker generated on the source bus line by an electric potential difference between the source bus line and a counter electrode.

It is thus possible to hide the flicker generated on the, source bus line by use of the black matrix. Flickers are, however, visible in a liquid crystal display device including no black matrix unless an electric potential difference between source bus lines and a counter electrode is constant.

The flickers generated on the source bus lines are also visible unless the black matrix is accurately provided on the source bus lines. That is, the flickers generated on the source bus lines are possibly visible even in a case where the black matrix is provided on the source bus lines.

Generally, signals (voltages) that are inverted on a constant cycle are applied to a pixel electrode 101 and a counter electrode 103, so that liquid crystal is not deteriorated. As illustrated in, for example, (a) of FIG. 5, signals, which is an in-phase signal or a reversed phase signal, are applied to each of the pixel electrode 101 and the counter electrode 103, so that an electric potential difference between the pixel electrode 101 and the counter electrode 103 is always constant. (a) of FIG. 5 exemplifies a case where a voltage to be applied to liquid crystal between the pixel electrode 101 and the counter electrode 103, that is, a liquid crystal applied voltage becomes 0 V (white display: in a case of normally white). In such a case, no flicker occurs between the pixel electrode 101 and the counter electrode 103 due to a fluctuation in electric potential difference between the pixel electrode 101 and the counter electrode 103.

Meanwhile, any one of an “H” signal (a high level signal for selecting black display) or an “L” signal (a low level signal for selecting white display) is always supplied to each of the source bus lines that is an output signal line of a binary driver. Therefore, an electric potential difference fluctuates between a source bus line Sn and the counter electrode 103 (see, for example, (b) of FIG. 5), in a case where the signals that are inverted on the constant cycle are thus applied to the counter electrode 103. (b) of FIG. 5 exemplifies a case where a voltage to be applied across liquid crystal between the source bus line Sn and the counter electrode 103, that is, a liquid crystal applied voltage alternates between 0 V and 5 V. This causes a problem that flickers are generated between the source bus line Sn and the counter electrode 103 due to a fluctuation in the electric potential difference between the source bus line Sn and the counter electrode 103.

The flickers generated due to the fluctuation in the electric potential difference between the source bus line Sn and the counter electrode 103 are possibly visible regardless of whether or not a black matrix is provided. This causes a decrease in display quality.

The present invention was made in view of the problem, and an object of the present invention is to provide a liquid crystal display device excellent in its display quality, in which liquid crystal display device no flicker is visible, regardless of whether or not a black matrix is provided on source bus lines, by preventing flickers generated between the source bus lines and a counter electrode.

### Solution to Problem

In order to attain the object, a liquid crystal display device of the present invention is a liquid crystal display device, including: an active matrix substrate; a counter substrate; liquid crystal capacitors sealed between the active matrix substrate and the counter substrate; a plurality of data signal lines provided on the active matrix, substrate; a plurality of scanning signal lines provided on the active matrix substrate; pixel electrodes provided, in a matrix manner on the active matrix substrate, for respective intersecting sections of the plurality of data signal lines and the plurality of scanning signal lines; and a counter electrode, provided on the counter substrate so as to face the pixel electrodes provided on the active matrix substrate, for applying a counter voltage to the liquid crystal capacitors in synchronization with voltages to be applied to the respective pixel electrodes, signals, each of which is an in-phase signal or a reversed phase signal of a signal supplied to the counter electrode, being supplied to the respective plurality of data signal lines during a video signal unwritten period, where (i) a video signal written period represents a period during which voltages are applied to the respective pixel electrodes in accordance with video signals to be supplied to the respective plurality of data signal lines and (ii) the video signal unwritten period represents a period between respective adjacent two video signal written periods.

A method for driving a liquid crystal display device of the present invention is a method for driving a liquid crystal display device, the liquid crystal display device, including: an active matrix substrate; a counter substrate; liquid crystal capacitors sealed between the active matrix substrate and the counter substrate; a plurality of data signal lines provided on the active, matrix substrate; a plurality of scanning signal lines provided on the active matrix substrate; pixel electrodes provided, in a matrix manner on the active matrix substrate, for respective intersecting sections of the plurality of data signal lines and the plurality of scanning signal lines; and a counter electrode, provided on the counter substrate so as to face the pixel electrodes provided on the active matrix substrate, for applying a counter voltage to the liquid crystal capacitors in synchronization with voltages to be applied to the respective pixel electrodes, said method including the step of: supplying, to the respective plurality of data signal lines during a video signal unwritten period, signals, each of which is an in-phase signal or a reversed phase signal of a signal supplied to the counter electrode, where (i) a video signal written period represents a period during which voltages are applied to the respective pixel electrodes in accordance with video signals to be supplied to the respective plurality of data signal lines and (ii) the video signal unwritten period represents a period between respective adjacent two video signal written periods.

According to the configuration, the signals, each of which is the in-phase signal or the reversed phase signal of the signal supplied to the respective plurality of data signal lines during the video signal unwritten period. This allows an electric potential difference between the plurality of data signal lines and the counter electrode to become constant. It is therefore possible to prevent flickers from being generated on the plurality of data signal lines during the video signal unwritten period due to a non-constant electric potential difference. Hence, a decrease in display quality caused by the flickers can be prevented.

Another liquid crystal display device of the present invention is a liquid crystal display device, including: an active matrix substrate; a counter substrate; light diffusing liquid crystal, which is (i) sealed between the active matrix substrate and the counter substrate, (ii) becomes a first display state where liquid crystal molecules irregularly align while no voltage is applied to the light diffusing liquid crystal, and (iii) becomes a second display state where the liquid crystal molecules regularly align while a voltage is applied to the light diffusing liquid crystal; a plurality of data signal lines, provided on the active matrix substrate, for transmitting a plurality of respective video signals for an image to be displayed; a plurality of scanning signal lines provided on the active matrix substrate so as to intersect with the plurality of respective data signal lines; pixel electrodes provided, in a matrix manner on the active matrix substrate, for respective intersecting sections of the plurality of data signal lines and the plurality of scanning signal lines; display data storage circuits, provided for the respective pixel electrodes, each for, in response to a video signal transmitted by a corresponding one of the plurality of data signal lines, (a) fetching, through a first supply line, first display data which allows the light diffusing liquid crystal to become the first display state, (b) fetching, through a second supply line, second display data which allows the light diffusing liquid crystal to become the second display state, and (c) storing the first display data and the second display data; and a counter electrode, provided on the counter substrate so as to face the pixel electrodes provided on the active matrix substrate, for applying a counter voltage to the light diffusing liquid crystal in synchronization with voltages to be applied to the respective pixel electrodes, signals, each of which is an in-phase signal or a reversed phase signal of a signal supplied to the counter electrode, being supplied to the respective plurality of data signal lines during a video signal unwritten period, where (i) a video signal written period represents a period during which voltages are applied to the respective pixel electrodes in accordance with video signals to be supplied to the respective plurality of data signal lines and (ii) the video signal unwritten period represents a period between respective adjacent two video signal written periods.

A method for driving another liquid crystal display device of the present invention is a method for driving a liquid crystal display device, the liquid crystal display device, including: an active matrix substrate; a counter substrate; light diffusing liquid crystal, which is (i) sealed between the active matrix substrate and the counter substrate, (ii) becomes a first display state where liquid crystal molecules irregularly align while no voltage is applied to the light diffusing liquid crystal, and (iii) becomes a second display state where the liquid crystal molecules regularly align while a voltage is applied to the light diffusing liquid crystal; a plurality of data signal lines, provided on the active matrix substrate, for transmitting a plurality of respective video signals for an image to be displayed; a plurality of scanning signal lines provided on the active matrix substrate so as to intersect with the plurality of respective data signal lines; pixel electrodes provided, in a matrix manner on the active matrix substrate, for respective intersecting sections of the plurality of data signal lines and the plurality of scanning signal lines; display data storage circuits, provided for the respective pixel electrodes, each for, in response to a video signal transmitted by a corresponding one of the plurality of data signal lines, (a) fetching, through a first supply line, first display data which allows the light diffusing liquid crystal to become the first display state, (b) fetching, through a second supply line, second display data which allows the light diffusing liquid crystal to become the second display state, and (c) storing the first display data and the second display data; and a counter electrode, provided on the counter substrate so as to face the pixel electrodes provided on the active matrix substrate, for applying a counter voltage to the light diffusing liquid crystal in synchronization with voltages to be applied to the respective pixel electrodes, said method including the step of: supplying, to the respective plurality of data signal lines during a video signal unwritten period, signals, each of which is an in-phase signal or a reversed phase signal of a signal supplied to the counter electrode, where (i) a video signal written period represents a period during which voltages are applied to the respective pixel electrodes in accordance with video signals to be supplied to the respective plurality of data signal lines and (ii) the video signal unwritten period represents a period between respective adjacent two video signal written periods. According to the configuration, the signals, each of which is the in-phase signal or the reversed phase signal of the signal supplied to the respective plurality of data signal lines during the video signal unwritten period. This allows an electric potential difference between the plurality of data signal lines and the counter electrode to become constant. It is therefore possible to prevent flickers from being generated on the plurality of data signal lines during the video signal unwritten period due to a non-constant electric potential difference. Hence, a decrease in display quality caused by the flickers can be prevented.

### Advantageous Effects of Invention

A liquid crystal display device of the present invention includes: an active matrix substrate; a counter substrate; liquid crystal sealed between the active matrix substrate and the counter substrate; a plurality of data signal lines provided on the active matrix substrate; a plurality of scanning signal lines provided on the active matrix substrate; pixel electrodes provided, in a matrix manner on the active matrix substrate, for respective intersecting sections of the plurality of data signal lines and the plurality of scanning signal lines; and a counter electrode, provided on the counter substrate so as to face the pixel electrodes provided on the active matrix substrate, for applying a counter voltage to the liquid crystal in synchronization with voltages to be applied to the respective pixel electrodes. Signals, each of which is an in-phase signal or a reversed phase signal of a signal supplied to the counter electrode, are supplied to the respective plurality of data signal lines during a video signal unwritten period, where (i) a video signal written period represents a period during which voltages are applied to the respective pixel electrodes in accordance with video signals to be supplied to the respective plurality of data signal lines and (ii) the video signal unwritten period represents a period between end of the data written period and start of a next data written period. This allows an electric potential difference between the plurality of data signal lines and the counter electrode to become constant. It is therefore possible to prevent flickers from being generated on the plurality of data signal lines during the video signal unwritten period due to a non-constant electric potential difference. This brings about an effect that a decrease in display quality caused by the flickers can be prevented.

### BRIEF DESCRIPTION OF DRAWINGS

FIG. 1

FIG. 1 is a block diagram schematically illustrating a configuration of a liquid crystal display device in accordance with an embodiment of the present invention.

FIG. 2

FIG. 2 is a planar view schematically illustrating a major part of an active area of the liquid crystal display device illustrated in FIG. 1.

FIG. 3

FIG. 3 is a view schematically illustrating a configuration of a pixel of the active area illustrated in FIG. 2.

FIG. 4

FIG. 4 is a cross-sectional view schematically illustrating the active area illustrated in FIG. 2.

FIG. 5

(a) of FIG. 5 is a waveform diagram illustrating an electric potential difference between a counter electrode and a pixel electrode. (b) of FIG. 5 is a conventional waveform diagram illustrating an electric potential difference between a counter electrode and a source bus line. (c) of FIG. 5 is a waveform diagram of the present invention, illustrating an electric potential difference between a counter electrode and a source bus line.

FIG. 6

FIG. 6 is a waveform diagram illustrating a cycle in which each of a counter electrode applied signal Vcom, a black writing signal VA, and a white writing signal VB is inverted.

FIG. 7

FIG. 7 is a circuit diagram of a polarity controller provided in the liquid crystal display device illustrated in FIG. 1.

FIG. 8

FIG. 8 is a circuit diagram exemplifying a circuit of a binary driver provided in the liquid crystal display device illustrated in FIG. 1.

FIG. 9

FIG. 9 is a timing chart of signals transmitted so as to drive the binary driver having a circuit configuration illustrated in FIG. 8.

FIG. 10

FIG. 10 is a circuit diagram exemplifying another circuit of the binary driver provided in the liquid crystal display device illustrated in FIG. 1.

FIG. 11

FIG. 11 is a timing chart of signals transmitted so as to drive the binary driver having a circuit configuration illustrated in FIG. 10.

FIG. 12

FIG. 12 is a block diagram schematically illustrating a configuration of another liquid crystal display device in accordance with an embodiment of the present invention.

### DESCRIPTION OF EMBODIMENTS

The following description will discuss in detail an embodiment of the present invention.

(Schematic Configuration of Liquid Crystal Display Device)

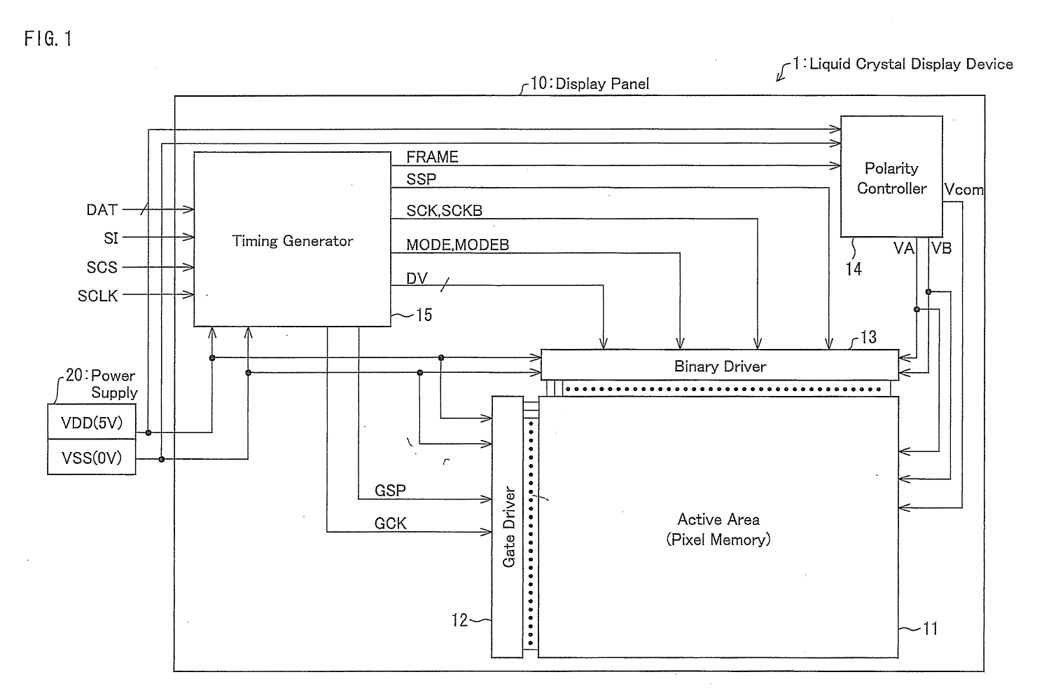

FIG. 1 is a block diagram schematically illustrating a configuration of a liquid crystal display device in accordance with an embodiment of the present invention.

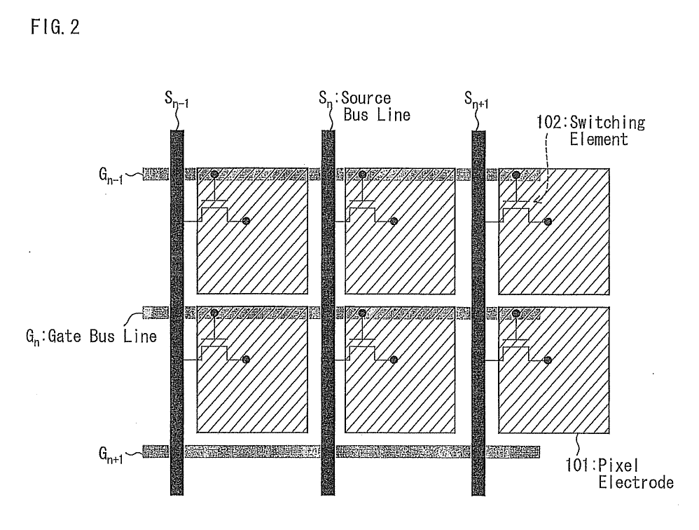

FIG. 2 is a view schematically illustrating a configuration of a display panel of the liquid crystal display device.

FIG. 3 is a view schematically illustrating a configuration of a pixel of the display panel.

As illustrated in FIG. 1, a liquid crystal display device 1 in accordance with the present embodiment includes a display panel 10, and a power supply 20 for driving the display panel 10.

The display panel 10 includes an active area 11, a gate driver (scanning signal line driving circuit) 12, a binary driver (data signal line driving circuit) 13, a polarity controller (signal supply circuit) 14, and a timing generator 15. Pixels of 320 dots×240 dots (length×width) are provided in the active area 11.

As illustrated in FIG. 2, the display panel 10 includes (i) source bus lines Sn (data signal lines), (ii) gate bus lines Gn (scanning signal lines), (iii) switching elements 102 provided in respective sections, in each of which sections one of the source bus lines Sn intersects with a corresponding one of the gate bus lines Gn, and (iv) pixels provided in a matrix manner, in each of which pixels a pixel electrode 101 is provided via a corresponding one of the switching elements 102. Note that FIG. 2 illustrates no pixel memory circuit (later described) for convenience.

As illustrated in FIG. 3, a pixel includes (i) a switching element 102 which is (a) a CMOS TFT-made up of a P type TFT and an N type TFT and (b) provided in a section where a source bus line Sn intersects with a gate bus line Gn, (ii) a memory circuit 105 connected to a drain electrode of the switching element 102 and (iii) a pixel electrode 101 which is connected to an output of the memory circuit 105 via a switching element 106. A liquid crystal capacitor 104 is provided between the pixel electrode 101 and a counter electrode 103. A difference between a voltage applied to the pixel electrode 101 and a voltage applied to the counter electrode 103 is applied, as a liquid crystal applied voltage, across the liquid crystal capacitor 104.

The switching element 106 is configured to switch a signal between a black writing signal (hereinafter, referred to as a black writing signal VA) and a white writing signal (hereinafter, referred to as a white writing signal VB) so as to supply the signal to the pixel electrode 101 in response to an output from the memory circuit 105.

In the pixel, the switching element 102 is turned on upon reception of a scanning signal applied to the gate bus line Gn. This causes a video signal applied to the source bus line Sn to be supplied to the memory circuit 105.

The scanning signal is applied to the gate bus line Gn by the gate driver 12, and the video signal is applied to the source bus line Sn by the binary driver 13.

The gate driver 12 repeatedly applies an active scanning signal to each of the gate bus lines for each vertical scanning period, in response to a gate start pulse signal GSP and a gate clock signal GCK. This causes each of the gate bus lines to be sequentially selected for each horizontal scanning period. That is, the gate driver 12 employs a driving method in which each of the gate bus lines is sequentially selected for each horizontal scanning period.

The binary driver 13 receives a digital video signal DV, a source start pulse signal SSP, source clock signals SCK and SCKB, and mode signals MODE and MODEB, and then applies a driving video signal to each of the source bus lines.

The binary driver 13 also receives the above-described black writing signal VA and white writing signal VB, and then applies, as the video signal, the black writing signal VA or the white writing signal VB to each of the source bus lines.

The black writing signal VA and the white writing signal VB are supplied from the polarity controller 14 to the binary driver 13. The black writing signal VA and the white writing signal VB are also supplied from the polarity controller 14 to each of the pixel electrodes 101 of the active area 11, as early described.

The polarity controller 14 creates a counter electrode applied signal Vcom, the black writing signal VA, and the white writing signal VB in response to (i) a frame signal FRAME from the timing generator 15 and (ii) voltages VDD and

VSS which are received from the power supply 20. The polarity controller 14 will be later described in detail.

The timing generator 15 creates a digital video signal DV in response to externally supplied image data DAT and display mode instruction signal M, and then supplies the digital video signal DV to the binary driver 13.

In response to serial data SI, a serial clock SCLK, and a serial chip select signal SCS which are supplied from an outside of the display panel 10, the timing generator 15 creates mode signals MODE and MODEB, a frame signal FRAME, source clocks SCK and SCKB (each of which is a timing signal serving as a clock signal which causes a shift register of a data signal line driver to operate), a source start pulse SSP (a timing signal for a horizontal period), a gate clock GCK (a timing signal to be supplied to a shift register of a gate signal line driver), and a gate start pulse GSP.

The timing generator 15 supplies (i) a source start pulse SSP to the binary driver 13, (ii) a gate clock GCK and a gate start pulse GSP to the gate driver 12, and (iii) a frame signal FRAME to the polarity controller 14. Source clocks SCK and SCKB each become a clock signal which causes a shift register of the binary driver 13 to operate.

(How to Prevent Flickers)

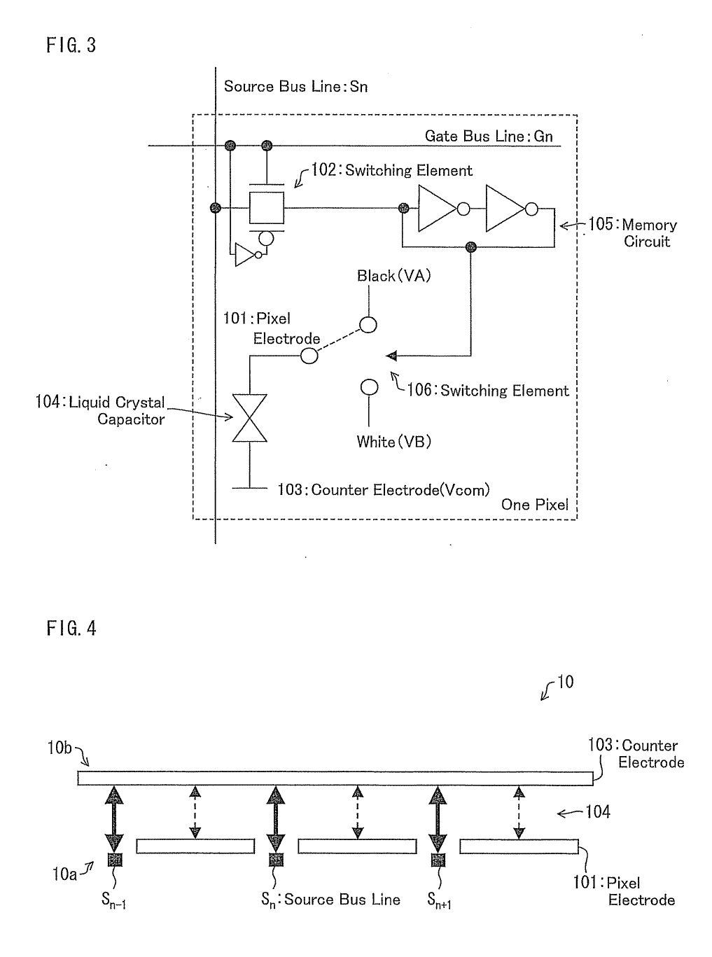

According to the display panel 10, liquid crystal capacitors 104 are sealed between an active matrix substrate 10a and a counter substrate 10b (see FIG. 4). A plurality of source bus lines Sn, a plurality of gate bus lines Gn (not shown), and pixel electrodes 101 are provided on the active matrix substrate 10a. The pixel electrodes 101 are provided, in a matrix manner, for respective intersecting sections of the plurality of source bus lines Sn and the plurality of gate bus lines Gn. A counter electrode 103 is provided on the counter substrate 10b so as to face the pixel electrodes 101 provided on the active matrix substrate 10a. The counter electrode 103 applies a counter voltage to the liquid crystal capacitors 104 in synchronization with voltages to be applied to the respective pixel electrodes 104.

According to the display panel 10 illustrated in FIG. 4, there is provided no black matrix on the source bus lines Sn. Therefore, flickers generated on the source bus lines Sn are visible.

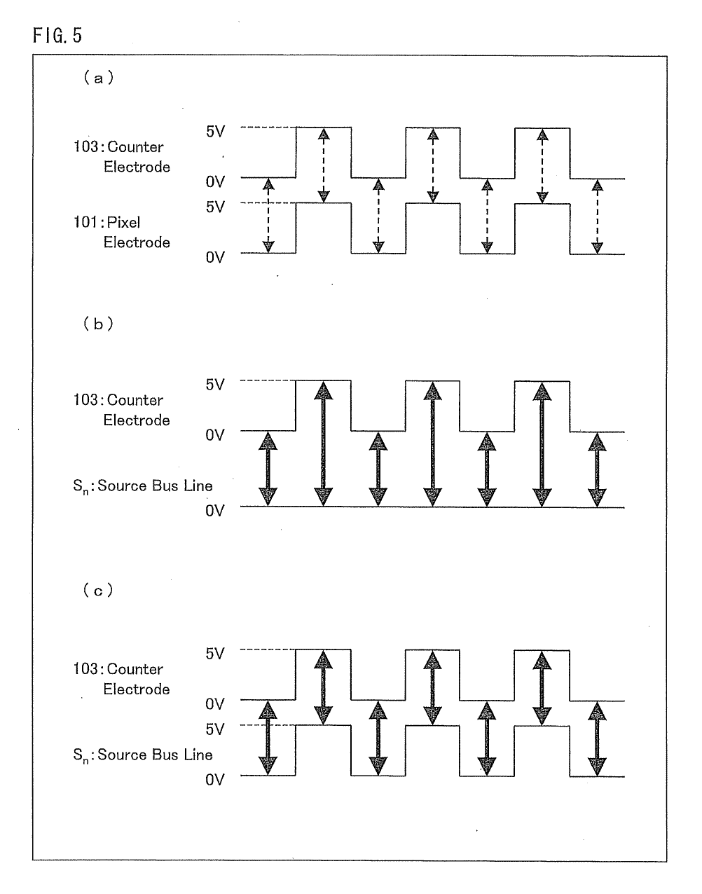

(a) of FIG. 5 is a timing chart illustrating an electric potential difference, generated during an unwritten period, between the counter electrode 103 and a pixel electrode 101. Each of (b) and (c) of FIG. 5 is a timing chart illustrating an electric potential difference, generated during an unwritten period, between the counter electrode 103 and a source bus line Sn.

Signals (voltages), that are inverted on a constant cycle, are applied to the pixel electrode 101 and the counter electrode 103 so that liquid crystal is not deteriorated. As illustrated in (a) of FIG. 5, signals (in-phase signals) that are inverted on a constant cycle at the same timing are applied to the pixel electrode 101 and the counter electrode 103 so that an electric potential difference between the pixel electrode 101 and the counter electrode 103 becomes always constant. (a) of FIG. 5 exemplifies a case where a voltage to be applied to liquid crystal between the pixel electrode 101 and the counter electrode 103, that is, a liquid crystal applied voltage becomes 0 V (white display: in a case of normally white). In such a case, no flicker occurs between the pixel electrode 101 and the counter electrode 103 due to a fluctuation in the electric potential difference between the pixel electrode 101 and the counter electrode 103.

Meanwhile, any one of an “H” signal (a high level signal for selecting black display) and an “L” signal (a low level signal for selecting white display) is always supplied to the source bus line Sn that is an output signal line of the binary driver 13. Therefore, an electric potential difference fluctuates between the source bus line Sn and the counter electrode 103 (see (b) of FIG. 5), in a case where the signals that are inverted on the constant cycle are thus applied to the counter electrode 103. (b) of FIG. 5 exemplifies a case where a voltage (i.e., a liquid crystal applied voltage) to be applied across a liquid crystal capacitor 104 between the source bus line Sn and the counter electrode 103 alternates between 0 V and 5V. This causes a problem that flickers are generated between the source bus line Sn and the counter electrode 103 due to a fluctuation in the electric potential difference between the source bus line Sn and the counter electrode 103.

In order to address such a problem, the liquid crystal display device 1 is configured to supply, to the source bus line Sn, a signal so that the electric potential difference between the source bus line Sn and the counter electrode 103 becomes constant (see (c) of FIG. 5). Such a signal to be supplied to the source bus line Sn is preferably (i) an in-phase signal whose polarity reversal and reversal timing are identical to those of a signal supplied to the counter electrode 103 or (ii) a reversed phase signal whose polarity is reversed to a polarity of the signal supplied to the counter electrode 103. According to the present embodiment, the above-described black writing signal VA or white writing signal VB to be supplied from the polarity controller 14 is employed as (a) the in-phase signal or (b) the reversed phase signal. (c) of FIG. 5 exemplifies a case where the white writing signal VB is supplied to the source bus line Sn. In (c) of FIG. 5, the electric potential difference between the source bus line Sn and the counter electrode 103 is 0 V. That is, the liquid crystal applied voltage is constantly kept to 0 V.

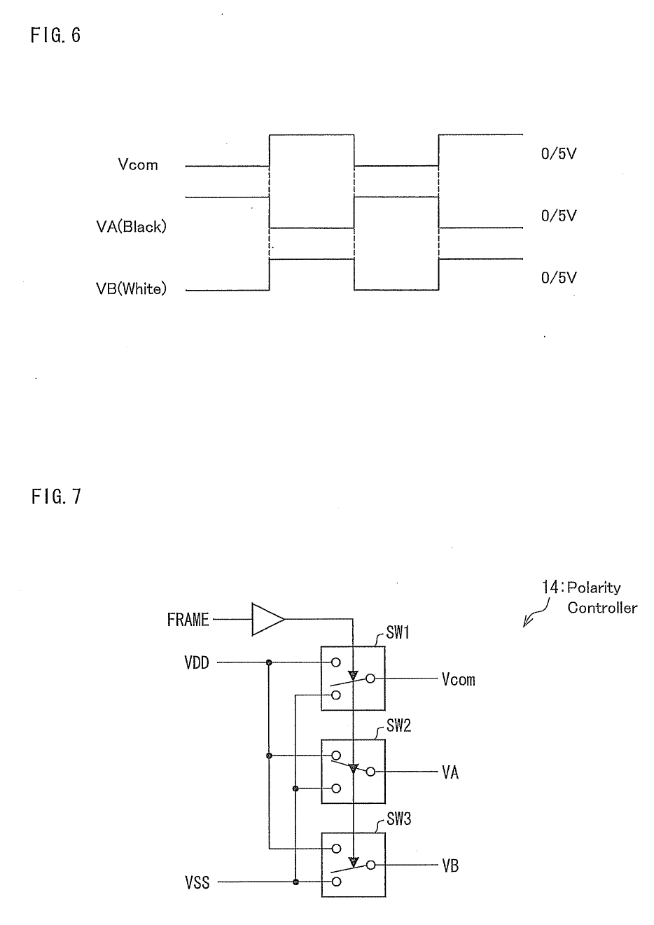

Note that, according to the present embodiment, each of the counter electrode applied signal Vcom, the black writing signal VA, and the white writing signal VB is inverted from 0 V to 5 V or vice versa. In FIG. 6, the counter electrode applied signal Vcom and the white writing signal VB are respective in-phase signals, whereas the counter electrode applied signal Vcom and the black writing signal VA are reverse phase signals. Since the counter electrode applied signal Vcom and the white writing signal VB are respective in-phase signals, the electric potential difference between the counter electrode 103 and the source bus line Sn is made constant (0 V) by supplying, during an unwritten period, the white writing signal VB to the source bus line Sn.

Note that (i) a video signal written period represents a period during which a voltage is applied to the pixel electrode 101 in accordance with a video signal to be supplied to the source bus line Sn and (ii) a video signal unwritten period represents a period between adjacent two video signal written periods.

According to the liquid crystal display device and a method for driving the liquid crystal display device, the electric potential difference between the source bus line Sn and the counter electrode 103 can be made constant by supplying, during the video signal unwritten period, to the source bus line Sn an in-phase signal or a reversed phase signal of the signal supplied to the counter electrode 103. This makes it possible to prevent a flicker from being generated on the source bus line Sn during the video signal unwritten period due to a non-constant electric potential difference between the source bus line Sn and the counter electrode 103. It is therefore possible to prevent a decrease in display quality, which decrease is caused by the flicker.

Therefore, even in a case where no black matrix is provided on the source bus line Sn as illustrated in FIG. 4, it is possible to suppress generation of a flicker by keeping a constant electric potential difference between the source bus line Sn and the counter electrode 103. That is, no flicker is visible on the source bus line Sn. It is therefore possible to prevent a decrease in display quality, which decrease is caused by the flicker.

As early described, the counter electrode applied signal Vcom, the black writing signal VA, and the white writing signal VB are created by the polarity controller 14.

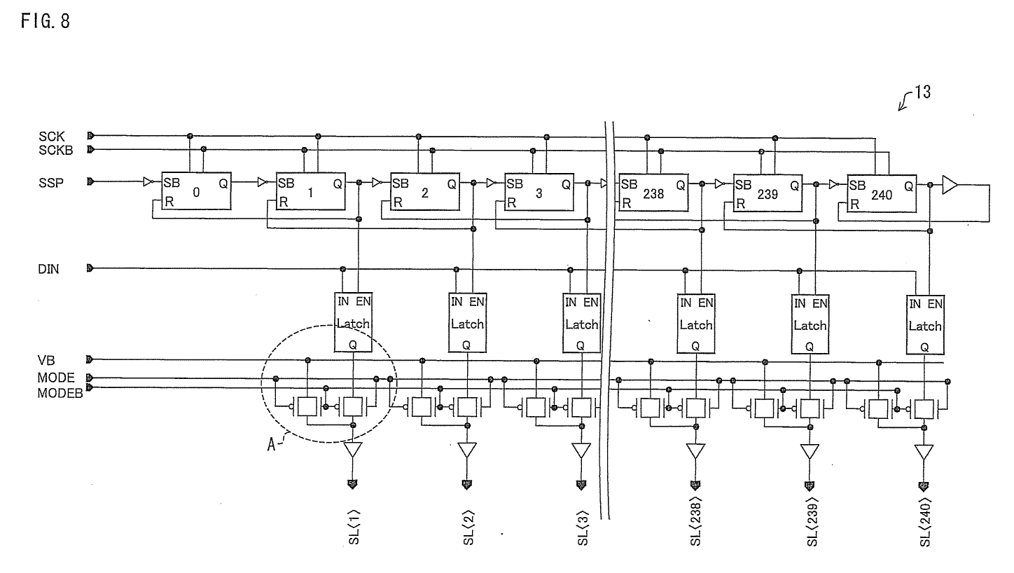

FIG. 7 illustrates a concrete circuit of the polarity controller 14.

In the polarity controller 14, a frame signal FRAME is supplied as a control signal, via a buffer, to switches SW1, SW2, and SW3, each of which is a C-contact. The switches SW1, SW2, and SW3 are provided for outputting a voltage of the counter electrode applied signal Vcom, a voltage of the black writing signal VA, and a voltage of the white writing signal VB, respectively. Each time when the frame signal FRAME is switched from Low to High or vice versa, the switches SW1, SW2, and SW3 output VDD, VSS, and VDD or VSS, VDD, and VSS. This causes the polarity controller 14 to output the counter electrode applied signal Vcom, the black writing signal VA, and the white writing signal VB on a reversal cycle (see FIG. 6).

(Description of Binary Driver)

FIG. 8 is a block diagram schematically illustrating a configuration of the binary driver 13.

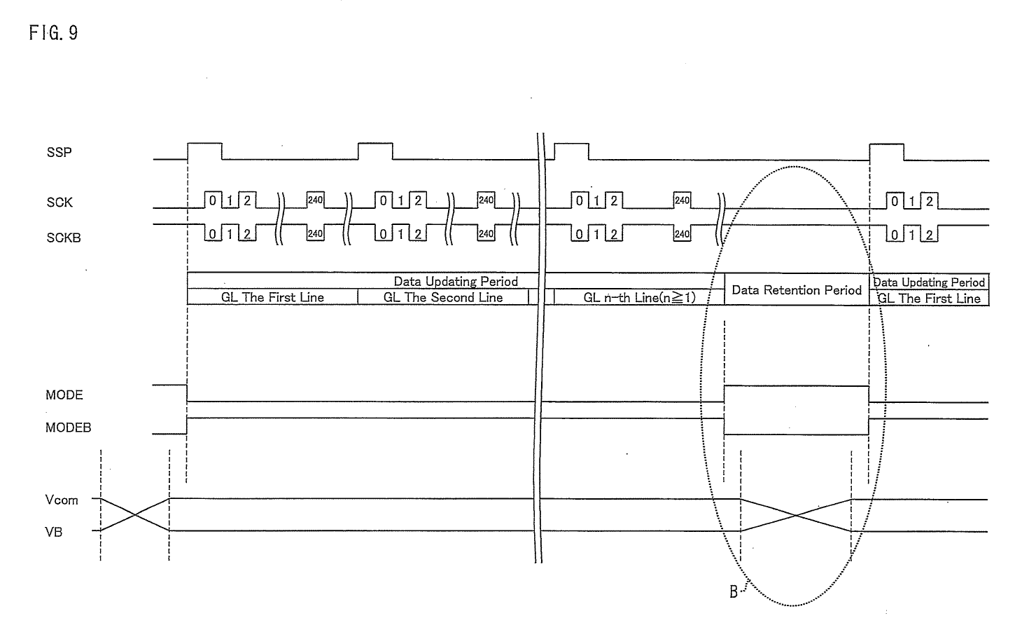

FIG. 9 illustrates a timing chart of signals of the binary driver 13 illustrated in FIG. 8.

The binary driver 13 includes 241 shift registers made up of (i) 240 shift registers (1st through 240th shift registers) provided for respective 240 pixels laterally aligned in the active area 11 and (ii) a shift register (0th shift resister). Each of the 1st through 240th shift registers has an output terminal connected to a corresponding latch circuit for latching a corresponding digital video signal DV.

Source clock signals SCK and SCKB are supplied to each of the 241 shift registers. Each of the 1st through 240th shift registers has an output terminal connected to a corresponding latch circuit. Each of the latch circuits (i) latches a corresponding digital video signal DV and then (ii) supplies the corresponding digital video signal DV to a corresponding signal line SL<n> connected to a corresponding source bus line Sn, in response to an output from a corresponding one of the shift registers. “n” is an integer ranging from 1 to 240.

The binary driver 13 is different from a normal binary driver in that the binary driver 13 further includes switching sections A each for switching between a digital video signal DV and a white writing signal VB. A switching section A is provided between respective latch circuits and respective signal lines SL<n>, from which the respective digital video signals DV or the white writing signal VB are outputted.

Each of the switching sections A includes first and second switching elements aligned in series with each other, each of which switching elements is a CMOS TFT. The switching section A thus switches between a digital video signal DV and a white writing signal VB. Specifically, in the first switching element, (i) a source electrode is connected to a white writing signal VB, (ii) two gate electrodes are connected to a mode signal MODE and a mode signal MODES that is an inversion signal of the mode signal MODE, and (iii) a drain electrode is connected to a corresponding signal line SL. In the second switching element, (a) a source electrode is connected to an output terminal of a corresponding latch circuit, (b) two gate electrodes are connected to the mode signal MODEB and the mode signal MODE that is an inversion signal of the mode signal MODEB, and (c) a drain electrode is connected to the corresponding signal line SL.

In the above-configured switching section A, the mode signal MODES is of course “Low” level when the mode signal MODE is “High” level. This causes the first switching element to be turned on, whereas the second switching element to be turned off. Therefore, the white writing signal VB is supplied to the signal line SL.

Meanwhile, the mode signal MODEB is “High” level when the mode signal MODE is “Low” level. In this case, the first switching element is turned off, whereas the second switching element is turned on. This causes the digital video signal DV, latched by the latch circuit, to be supplied to the signal line SL.

The mode signal MODE is switched to “High” level at a timing when a data unwritten period (a data retention period that is region B in FIG. 9) starts. The data unwritten period is a period between end of a data written period during which one frame data is written and start of a next data written period during which subsequent frame data is written (see FIG. 9).

The white writing signal VB to be supplied to the signal line SL during the data unwritten period and the counter electrode applied signal Vcom (see FIG. 6) are respective in-phase signals. Therefore, an electric potential difference between the source bus line Sn connected to the signal line SL and the counter electrode 103 becomes constant. FIG. 9 shows that an electric potential difference (Vcom/VB) is constant in the region B. That is, the electric potential difference meets a relationship such as that illustrated in (c) of FIG. 5.

In the binary driver 13 illustrated in FIG. 8, the white writing signal VB is switched, and the white writing signal VB and the counter electrode applied signal Vcom are respective in-phase signals. Alternatively, a black writing signal VA can be switched instead of the white writing signal VB. Note that the black writing signal VA and the counter electrode applied signal Vcom (see FIG. 6) are respective reversed phase signals.

At a timing when the data written period is switched to the data unwritten period, the binary driver 13 switches from a low level signal (white writing signal VB) or a high level signal (black writing signal VA) to a signal which is an in-phase signal or a reversed phase signal of a signal supplied to the counter electrode 103. This allows the electric potential difference between the source bus line Sn and the counter electrode 103 to become constant immediately after start of the data unwritten period. It is therefore possible to reliably prevent flickers caused during the data unwritten period, so that display quality can be further improved.

Further, a signal to be supplied from the polarity controller 14 to the pixel electrode 101 is used as a signal to be outputted to the source bus line Sn during the data unwritten period. This allows the signals to be shared and it is therefore unnecessary to separately create a signal to be outputted to the source bus line Sn during the data unwritten period. As such, it is possible to employ existing circuits as they are. This ultimately allows an apparatus to be downsized without increase in its manufacturing cost.

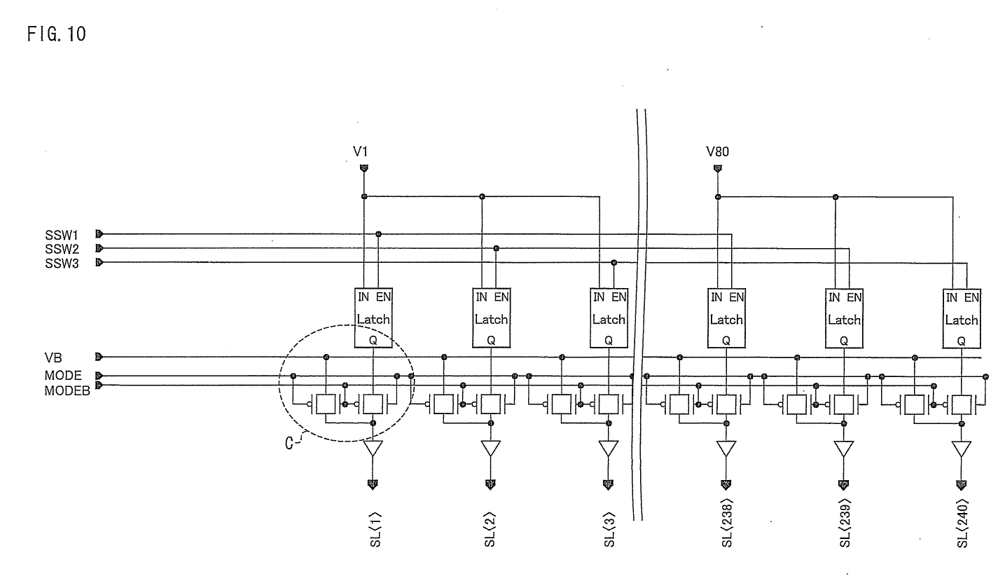

In the binary driver 13 illustrated in FIG. 8, the latch circuit latches a digital video signal DV by use of the shift register. However, the present embodiment is not limited to this. For example, like a binary driver 113 illustrated in FIG. 10, it is possible for a latch circuit to latch a digital video signal DV, instead of employing a shift register.

In the binary driver 113 illustrated in FIG. 10, digital video signals DV are divided into 80 groups (V1 through V80). In each of the groups, a digital video signal DV (for example, V1) is supplied to corresponding three latch circuits. Switching signals SSW1, SSW2, and SSW3 are supplied to the respective three latch circuits.

The switching signals SSW1, SSW2, and SSW3 are created by a driver IC (not shown) for driving the display panel 10, and are then supplied to the display panel 10.

The binary driver 113 illustrated in FIG. 10 also includes switching sections C each for switching between an output from a corresponding latch circuit and a white writing signal VB, as with the binary driver 13 illustrated in FIG. 8. Each of the switching sections C has a configuration identical to that of the switching section A illustrated in FIG. 8, and therefore detailed description of the switching sections C is omitted here.

In each of the switching sections C of the binary driver 113 illustrated in FIG. 10, a mode signal MODEB is “Low” level when a mode signal MODE is “High” level, as with each of the switching sections A of the binary driver 13 illustrated in FIG. 8. This causes a first switching element of the switching sections C to be turned on, whereas a second switching element of the switching sections C to be turned off. In this case, a white writing signal VB is supplied to a corresponding signal line SL. Meanwhile, the mode signal MODEB is “High” level when the mode signal MODE is “Low” level. This causes the first switching element to be turned off, whereas the second switching element to be turned on. In this case, a digital video signal DV (V1) latched by a corresponding latch circuit is supplied to the corresponding signal line SL.

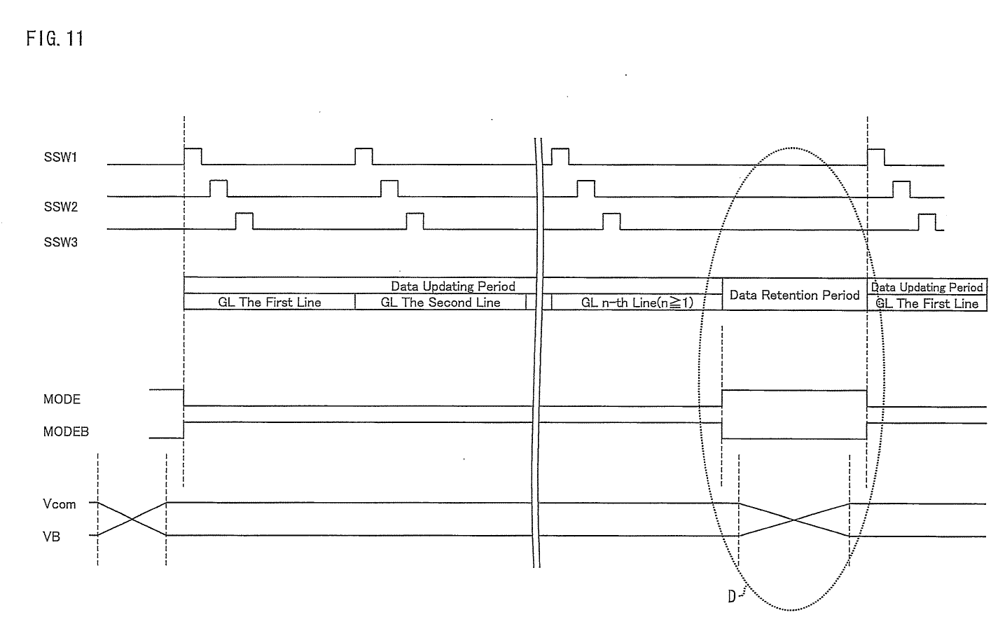

The mode signal MODE is switched to “High” level at a timing when a data unwritten period (a data retention period that is region D in FIG. 11) starts. The data unwritten period is a period between end of a data written period during which one frame data is written and start of a next data written period during which subsequent frame data is written (see FIG. 11).

The white writing signal VB to be supplied to the signal line SL during the data unwritten period and the counter electrode applied signal Vcom (see FIG. 6) are respective in-phase signals. Therefore, an electric potential difference between the source bus line Sn connected to the signal line SL and the counter electrode 103 becomes constant. FIG. 11 shows that an electric potential difference (Vcom/VB) is constant in the region D. That is, the electric potential difference meets a relationship such as that illustrated in (c) of FIG. 5.

The present invention has a beneficial effect on a configuration where no black matrix is provided between respective pixel electrodes 101. Note, however, that the present invention is applicable to a configuration where a black matrix is provided between respective pixel electrodes 101. With such a configuration, the black matrix serves as hiding flickers generated on source bus lines Sn, and therefore the flickers are unlikely visible. Note, however, that the flickers are visible unless the black matrix is accurately provided. Therefore, the present invention is applicable to a case where flickers need to be prevented, regardless of whether or not a black matrix is provided.

The present invention has thus a beneficial effect particularly on the configuration where no black matrix is provided between the respective pixel electrodes 101. Therefore, the present invention has a beneficial effect on a liquid crystal display device in which (i) no black matrix is provided and (ii) pixels are aligned at narrow intervals in the liquid crystal display device.

Liquid crystal has been described, without limiting to a specific one, in the present embodiment. For example, it is possible to employ light diffusing liquid crystal, which is used in a liquid crystal display device that employs a display panel including a pixel memory circuit. The light diffusing liquid crystal is suitably used particularly in a liquid crystal display device for displaying a high definition image on its display screen small in size, such as a liquid crystal display device used in a small mobile terminal.

The liquid crystal display device employing the light diffusing liquid crystal is configured by, for example, including an active matrix substrate; a counter substrate; light diffusing liquid crystal, which is (i) sealed between the active matrix substrate and the counter substrate, (ii) becomes a first display state where liquid crystal molecules irregularly align while no voltage is applied to the light diffusing liquid crystal, and (iii) becomes a second display state where the liquid crystal molecules regularly align while a voltage is applied to the light diffusing liquid crystal (the configuration is not shown).

On the active matrix substrate are provided (i) a plurality of data signal lines for transmitting a plurality of respective video signals for an image to be displayed, (ii) a plurality of scanning signal lines intersecting with the plurality of respective data signal lines, (iii) pixel electrodes provided in a matrix manner for respective intersecting sections of the plurality of data signal lines and the plurality of scanning signal lines, (iv) display data storage circuits, provided for the respective pixel electrodes, each for, in response to a video signal transmitted by a corresponding one of the plurality of data signal lines, (a) fetching, through a first supply line, first display data which allows the light diffusing liquid crystal to become the first display state, (b) fetching, through a second supply line, second display data which allows the light diffusing liquid crystal to become the second display state, and (c) storing the first display data and the second display data.

A counter electrode is provided on the counter substrate so as to face the pixel electrodes provided on the active matrix substrate. The counter electrode applies a counter voltage to the light diffusing liquid crystal in synchronization with voltages to be applied to the respective pixel electrodes.

As with the liquid crystal display device illustrated in FIG. 1, the liquid crystal display device employing the light diffusing liquid crystal is configured such that signals, each of which is an in-phase signal or a reversed phase signal of a signal supplied to the counter electrode, are supplied to the respective plurality of data signal lines during a video signal unwritten period, where (i) a video signal written period represents a period during which voltages are applied to the respective pixel electrodes in accordance with video signals to be supplied to the respective plurality of data signal lines and (ii) the video signal unwritten period represents a period between respective adjacent two video signal written periods.

According to the configuration, the signals, each of which is the in-phase signal or the reversed phase signal of the signal supplied to the respective plurality of data signal lines during the video signal unwritten period. This allows an electric potential difference between the plurality of data signal lines and the counter electrode to become constant. It is therefore possible to prevent flickers from being generated on the plurality of data signal lines during the video signal unwritten period due to a non-constant electric potential difference. Hence, a decrease in display quality caused by the flickers can be prevented.

According to the present embodiment, the gate driver 12 thus employs a driving method in which each gate bus line is sequentially selected for each horizontal scanning period. However, the present invention is not limited to the gate driver that employs such a line sequential driving method, but is applicable to a liquid crystal display device including a gate driver which employs a line address driving method for selectively driving only a gate line that needs to be rewritten.

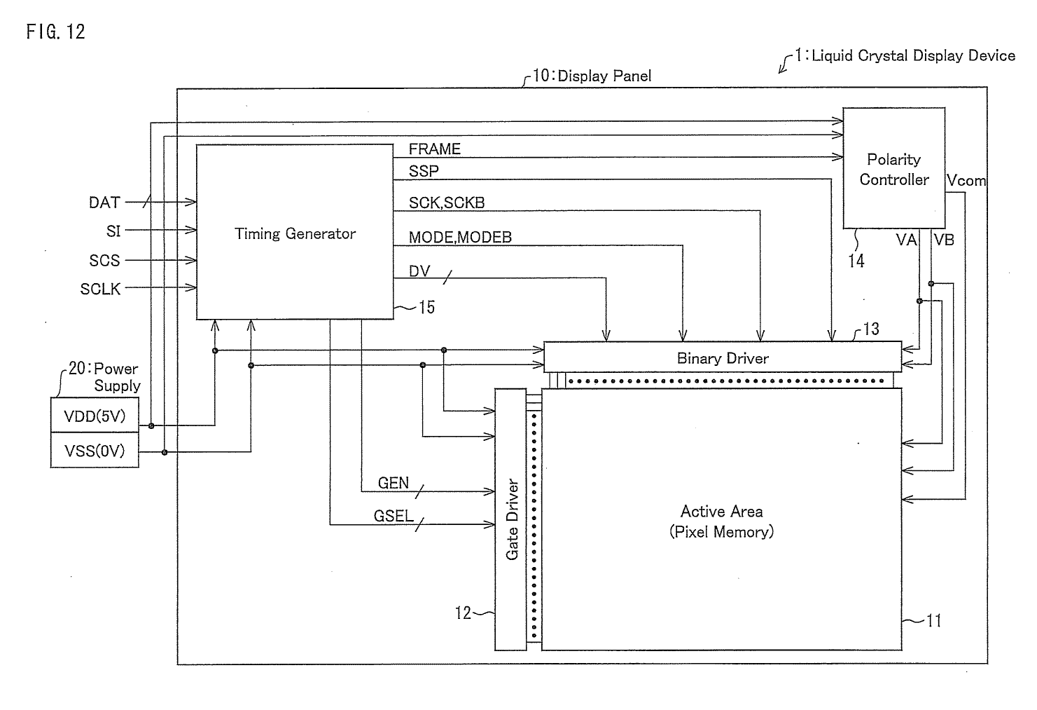

FIG. 12 illustrates a liquid crystal display device 1 including a gate driver which employs a line address driving method.

The liquid crystal display device 1 illustrated in FIG. 12 is different from the liquid crystal display device 1 illustrated in FIG. 1 merely in that different signals are supplied to the respective gate drivers 12 of FIG. 1 and FIG. 12. Specifically, in FIG. 1, the timing generator 15 supplies a gate start pulse signal GSP and a gate clock signal GCK to the gate driver 12, whereas, in FIG. 12, a timing generator 15 supplies signals GEN and signals GSEL to the gate driver 12.

The signals GEN and GSEL each are created by decoding address data of serial data SI. The address data indicates positional information of a pixel electrode in which a video signal is to be written. The timing generator 15 includes a decoding circuit in which the signals GEN and GSEL are created.

The signal GEN represents a signal for controlling a period during which a gate bus line is being selected. For example, in a case where the signal GEN is “High”, a gate bus line Gn selected on the basis of address data becomes active. This causes a pixel connected to the gate bus line Gn to become in an on state and fetch data from a corresponding source bus line Sn. Meanwhile, in a case where the signal GEN is “Low”, all lines become inactive. The signal GSEL represents a signal which obtained by decoding inputted address.

According to the liquid crystal display device 1 illustrated in FIG. 12, the gate driver 12 thus selectively drives the gate bus line Gn on the basis of the positional information of the pixel electrode in which the video signal is to be written. That is, only a gate bus line Gn that needs to be rewritten is driven.

It is therefore possible to elongate an unwritten period in the line address driving method as compared with the line sequential driving method, by selectively driving only a gate bus line Gn connected to a corresponding pixel electrode that needs to be rewritten.

This allows a stable adjustment for an electric potential difference between a source bus line Sn and a counter electrode during an unwritten period. It is therefore possible to reliably prevent generation of flickers during the unwritten period.

The present embodiment exemplifies an example where a black writing signal VA, a white writing signal VB, a mode signal MODE, a mode signal MODEB, and a counter electrode applied signal Vcom are created in the display panel 10 of the liquid crystal display device 1 illustrated in each of FIGS. 1 and 12. However, the present embodiment is not limited to this case. These signals can be created by a driver IC provided outside the display panel 10.

It is preferable that the liquid crystal display device further includes a binary driver for supplying a high level signal or a low level signal to the plurality of data signal lines, the binary driver serving as a data signal line driving circuit for driving the plurality of data signal lines, the binary driver switching between the high level signal and the low level signal so that the high level signal or the low level signal becomes an in-phase signal or a reversed phase signal, and supplying a corresponding switched signal to each of the plurality of data signal lines, at a timing when the video signal written period switches to the video signal unwritten period.

According to the configuration, the binary driver switches between the high level signal and the low level signal so that the high level signal or the low level signal becomes the in-phase signal or the reversed phase signal, and supplies the corresponding switched signal to each of the plurality of data signal lines, at the timing when the video signal written period switches to the video signal unwritten period. This allows an electric potential difference between the plurality of data signal lines and the counter electrode to become constant immediately after start of the video signal unwritten period. It is therefore possible to reliably prevent flickers from being generated during the video signal unwritten period. Hence, display quality can be further improved.

It is preferable that the liquid crystal display device further includes a signal supply circuit for supplying, to the pixel electrodes, signals each of which is an in-phase signal or a reversed signal of the signal supplied to the counter electrode, the binary driver employing, as the signals to be outputted to the respective plurality of data signal lines during the video signal unwritten period, the signals to be supplied from the signal supply circuit to the respective pixel electrodes.

According to the configuration, the signals to be supplied from the signal supply circuit to the respective pixel electrodes are employed as the signals to be outputted to the respective plurality of data signal lines during the video signal unwritten period. This allows the signals to be shared. It is therefore unnecessary to separately create a signal to be outputted to the plurality of data signal lines during the data unwritten period. As such, it is possible to employ existing circuits as they are. This ultimately allows an apparatus to be downsized without increase in its manufacturing cost.

It is preferable that the liquid crystal display device further includes a scanning signal line driving circuit for driving the plurality of scanning signal lines, the scanning signal line driving circuit selectively driving the plurality of scanning signal lines on the basis of positional information of the respective pixel electrodes to which respective video signals are to be written.

It is therefore possible to elongate an unwritten period in such a driving method as compared with a driving method in which each scanning signal line is sequentially selected for each horizontal scanning period, by selectively driving only a scanning signal line connected to a corresponding pixel electrode that needs to be rewritten.

This allows a stable adjustment for an electric potential difference between a source bus line Sn and a counter electrode during an unwritten period. It is therefore possible to reliably prevent generation of flickers during the unwritten period.

The liquid crystal display device is applicable to various electronic devices. The liquid crystal display device is preferably applicable to, for example, a liquid crystal television whose display quality should be improved. The liquid crystal display device is also applicable to a monitor for a personal computer. An electronic device employing the liquid crystal display device of the present invention as its display device can always display with an excellent display quality without flickers.

The present invention is not limited to the description of the embodiments above, and can therefore be modified by a skilled person in the art within the scope of the claims. Namely, an embodiment derived from a proper combination of technical means disclosed in different embodiments is encompassed in the technical scope of the present invention.

### INDUSTRIAL APPLICABILITY

The present invention is applicable to a liquid crystal display device in which an electric potential difference between a counter electrode and a pixel electrode is used as a liquid crystal applied voltage, and is particularly applicable to (i) a liquid crystal display device in which pixels are aligned at narrow intervals, and therefore no black matrix can be provided on data signal lines and (ii) an electronic device including the liquid crystal display device.

### REFERENCE SIGNS LIST

1: liquid crystal display device
10: display panel
11: active area
12: gate driver (scanning signal line driving circuit)
13: binary driver (data signal line driving circuit)
14: polarity controller
15: timing generator
20: power source
101: pixel electrode
102: switching element
103: counter electrode
104: liquid crystal capacitor
105: memory circuit
Sn: source bus line (data signal line)
Gn: gate bus line (scanning signal line)
DAT: image data
DV: digital video signal
VA: black writing signal
VB: white writing signal
Vcom: counter electrode applied signal

1. A liquid crystal display device, comprising:
an active matrix substrate;
a counter substrate;
liquid crystal capacitors sealed between the active matrix substrate and the counter substrate;
a plurality of data signal lines provided on the active matrix substrate;
a plurality of scanning signal lines provided on the active matrix substrate;
pixel electrodes provided, in a matrix manner on the active matrix substrate, for respective intersecting sections of the plurality of data signal lines and the plurality of scanning signal lines; and
a counter electrode, provided on the counter substrate so as to face the pixel electrodes provided on the active matrix substrate, for applying a counter voltage to the liquid crystal capacitors in synchronization with voltages to be applied to the respective pixel electrodes,
signals, each of which is an in-phase signal or a reversed phase signal of a signal supplied to the counter electrode, being supplied to the respective plurality of data signal lines during a video signal unwritten period, where (i) a video signal written period represents a period during which voltages are applied to the respective pixel electrodes in accordance with video signals to be supplied to the respective plurality of data signal lines and (ii) the video signal unwritten period represents a period between respective adjacent two video signal written periods.

2. A liquid crystal display device as set forth in claim 1, further comprising:
a binary driver for supplying a high level signal or a low level signal to the plurality of data signal lines, the binary driver serving as a data signal line driving circuit for driving the plurality of data signal lines,
the binary driver switching between the high level signal and the low level signal so that the high level signal and the low level signal becomes an in-phase signal or a reversed phase signal, and supplying a corresponding switched signal to each of the plurality of data signal lines, at a timing when the video signal written period switches to the video signal unwritten period.

3. A liquid crystal display device as set forth in claim 2, further comprising:
a signal supply circuit for supplying, to the pixel electrodes, signals each of which is an in-phase signal or a reversed signal of the signal supplied to the counter electrode,
the binary driver employing, as the signals to be outputted to the respective plurality of data signal lines during the video signal unwritten period, the signals to be supplied from the signal supply circuit to the respective pixel electrodes.

4. A liquid crystal display device, comprising:
an active matrix substrate;
a counter substrate;
light diffusing liquid crystal, which is (i) sealed between the active matrix substrate and the counter substrate, (ii) becomes a first display state where liquid crystal molecules irregularly align while no voltage is applied to the light diffusing liquid crystal, and (iii) becomes a second display state where the liquid crystal molecules regularly align while a voltage is applied to the light diffusing liquid crystal;
a plurality of data signal lines, provided on the active matrix substrate, for transmitting a plurality of respective video signals for an image to be displayed;
a plurality of scanning signal lines provided on the active matrix substrate so as to intersect with the plurality of respective data signal lines;
pixel electrodes provided, in a matrix manner on the active matrix substrate, for respective intersecting sections of the plurality of data signal lines and the plurality of scanning signal lines;
display data storage circuits, provided for the respective pixel electrodes, each for, in response to a video signal transmitted by a corresponding one of the plurality of data signal lines, (a) fetching, through a first supply line, first display data which allows the light diffusing liquid crystal to become the first display state, (b) fetching, through a second supply line, second display data which allows the light diffusing liquid crystal to become the second display state, and (c) storing the first display data and the second display data; and
a counter electrode, provided on the counter substrate so as to face the pixel electrodes provided on the active matrix substrate, for applying a counter voltage to the light diffusing liquid crystal in synchronization with voltages to be applied to the respective pixel electrodes,
signals, each of which is an in-phase signal or a reversed phase signal of a signal supplied to the counter electrode, being supplied to the respective plurality of data signal lines during a video signal unwritten period, where (i) a video signal written period represents a period during which voltages are applied to the respective pixel electrodes in accordance with video signals to be supplied to the respective plurality of data signal lines and (ii) the video signal unwritten period represents a period between respective adjacent two video signal written periods.

5. A liquid crystal display device as set forth in claim 1, further comprising:
a scanning signal line driving circuit for driving the plurality of scanning signal lines,
the scanning signal line driving circuit selectively driving the plurality of scanning signal lines on the basis of positional information of the respective pixel electrodes to which respective video signals are to be written.

6. A method for driving a liquid crystal display device,
the liquid crystal display device, comprising:
an active matrix substrate;
a counter substrate;
liquid crystal capacitors sealed between the active matrix substrate and the counter substrate;
a plurality of data signal lines provided on the active matrix substrate;
a plurality of scanning signal lines provided on the active matrix substrate;
pixel electrodes provided, in a matrix manner on the active matrix substrate, for respective intersecting sections of the plurality of data signal lines and the plurality of scanning signal lines; and
a counter electrode, provided on the counter substrate so as to face the pixel electrodes provided on the active matrix substrate, for applying a counter voltage to the liquid crystal capacitors in synchronization with voltages to be applied to the respective pixel electrodes,
said method comprising the step of:
supplying, to the respective plurality of data signal lines during a video signal unwritten period, signals, each of which is an in-phase signal or a reversed phase signal of a signal supplied to the counter electrode, where (i) a video signal written period represents a period during which voltages are applied to the respective pixel electrodes in accordance with video signals to be supplied to the respective plurality of data signal lines and (ii) the video signal unwritten period represents a period between respective adjacent two video signal written periods.

7. A method for driving a liquid crystal display device,
the liquid crystal display device, comprising:
an active matrix substrate;
a counter substrate;
light diffusing liquid crystal, which is (i) sealed between the active matrix substrate and the counter substrate, (ii) becomes a first display state where liquid crystal molecules irregularly align while no voltage is applied to the light diffusing liquid crystal, and (iii) becomes a second display state where the liquid crystal molecules regularly align while a voltage is applied to the light diffusing liquid crystal;
a plurality of data signal lines, provided on the active matrix substrate, for transmitting a plurality of respective video signals for an image to be displayed;
a plurality of scanning signal lines provided on the active matrix substrate so as to intersect with the plurality of respective data signal lines;
pixel electrodes provided, in a matrix manner on the active matrix substrate, for respective intersecting sections of the plurality of data signal lines and the plurality of scanning signal lines;
display data storage circuits, provided for the respective pixel electrodes, each for, in response to a video signal transmitted by a corresponding one of the plurality of data signal lines, (a) fetching, through a first supply line, first display data which allows the light diffusing liquid crystal to become the first display state, (b) fetching, through a second supply line, second display data which allows the light diffusing liquid crystal to become the second display state, and (c) storing the first display data and the second display data; and
a counter electrode, provided on the counter substrate so as to face the pixel electrodes provided on the active matrix substrate, for applying a counter voltage to the light diffusing liquid crystal in synchronization with voltages to be applied to the respective pixel electrodes,
said method comprising the step of:
supplying, to the respective plurality of data signal lines during a video signal unwritten period, signals, each of which is an in-phase signal or a reversed phase signal of a signal supplied to the counter electrode, where (i) a video signal written period represents a period during which voltages are applied to the respective pixel electrodes in accordance with video signals to be supplied to the respective plurality of data signal lines and (ii) the video signal unwritten period represents a period between respective adjacent two video signal written periods.

8. An electronic device, comprising a liquid crystal display device, the liquid crystal display device including:
an active matrix substrate;
a counter substrate;
liquid crystal capacitors sealed between the active matrix substrate and the counter substrate;
a plurality of data signal lines provided on the active matrix substrate;
a plurality of scanning signal lines provided on the active matrix substrate;
pixel electrodes provided, in a matrix manner on the active matrix substrate, for respective intersecting sections of the plurality of data signal lines and the plurality of scanning signal lines; and
a counter electrode, provided on the counter substrate so as to face the pixel electrodes provided on the active matrix substrate, for applying a counter voltage to the liquid crystal capacitors in synchronization with voltages to be applied to the respective pixel electrodes,
signals, each of which is an in-phase signal or a reversed phase signal of a signal supplied to the counter electrode, being supplied to the respective plurality of data signal lines during a video signal unwritten period, where (i) a video signal written period represents a period during which voltages are applied to the respective pixel electrodes in accordance with video signals to be supplied to the respective plurality of data signal lines and (ii) the video signal unwritten period represents a period between respective adjacent two video signal written periods.

9. An electronic device, comprising a liquid crystal display device, the liquid crystal display device including:
an active matrix substrate;
a counter substrate;
light diffusing liquid crystal, which is (i) sealed between the active matrix substrate and the counter substrate, (ii) becomes a first display state where liquid crystal molecules irregularly align while no voltage is applied to the light diffusing liquid crystal, and (iii) becomes a second display state where the liquid crystal molecules regularly align while a voltage is applied to the light diffusing liquid crystal;
a plurality of data signal lines, provided on the active matrix substrate, for transmitting a plurality of respective video signals for an image to be displayed;
a plurality of scanning signal lines provided on the active matrix substrate so as to intersect with the plurality of respective data signal lines;
pixel electrodes provided, in a matrix manner on the active matrix substrate, for respective intersecting sections of the plurality of data signal lines and the plurality of scanning signal lines;
display data storage circuits, provided for the respective pixel electrodes, each for, in response to a video signal transmitted by a corresponding one of the plurality of data signal lines, (a) fetching, through a first supply line, first display data which allows the light diffusing liquid crystal to become the first display state, (b) fetching, through a second supply line, second display data which allows the light-diffusing liquid crystal to become the second display state, and (c) storing the first display data and the second display data; and
a counter electrode, provided on the counter substrate so as to face the pixel electrodes provided on the active matrix substrate, for applying a counter voltage to the light diffusing liquid crystal in synchronization with voltages to be applied to the respective pixel electrodes,
signals, each of which is an in-phase signal or a reversed phase signal of a signal supplied to the counter electrode, being supplied to the respective plurality of data signal lines during a video signal unwritten period, where (i) a video signal written period represents a period during which voltages are applied to the respective pixel electrodes in accordance with video signals to be supplied to the respective plurality of data signal lines and (ii) the video signal unwritten period represents a period between respective adjacent two video signal written periods.
